(19) United States
(12) Patent Application Publication
(10) Pub. No.: US 2014/0280149 A1
(43) Pub. Date: Sep. 18, 2014

(54) METHOD AND SYSTEM FOR CONTENT AGGREGATION UTILIZING CONTEXTUAL INDEXING

(71) Applicants: Sathi T. Marath, NS (CA); Christien A. Lomax, NS (CA); Peter G. Hickey, NS (CA); Kate E. Kinnear, NS (CA)

(72) Inventors: Sathi T. Marath, NS (CA); Christien A. Lomax, NS (CA); Peter G. Hickey, NS (CA); Kate E. Kinnear, NS (CA)

(21) Appl. No.: 13/839,924

(22) Filed: Mar. 15, 2013

(51) Int. Cl. G06F 17/30

(52) U.S. Cl. CPC G06F 17/30619
USPC 707/737

(57) ABSTRACT

A content management system interconnects multiple information sources and enables rapid access to documents, files or email by creating a contextual indexing layer in which information is organized around the people and companies within an organization's network and then presents the linked information through an application interface layer allowing a user to find anything rapidly, without the use of traditional keyword searching.

### FIELD OF THE INVENTION

This disclosure relates to the field of data content aggregation, and, more particularly, to a system and methods for aggregating content across cloud sources.

### BACKGROUND OF THE INVENTION

Current aggregation service and product offerings such as those from Otixo, TeamBox, OpenEra, Jive, ZeroPC offer aggregation solutions which are focused on aggregating content across cloud sources and without the ability to organize and present information contextually.

### SUMMARY OF THE INVENTION

Disclosed is a cloud content management system that connects multiple information sources—including those currently available from Salesforce, Box, Google Drive, Gmail, and shared drives—to enable rapid access thereto without the need for searching. Contextual indexing enables delivery of documents, files or email when needed. Each file is linked to the people or companies the requester has interacted regardless of how or where it was saved.

The disclosed cloud content management system comprises two major components. The first component is a proprietary content management platform that creates a contextual indexing layer by automatically organizing information around the people and companies within an organization's network and then presenting it in a manner that allows a user to find anything in seconds, without the use of traditional keyword searching which is often ineffective in the enterprise.

The second major component is an application interface layer through which systems that were previously in competition, such as SharePoint and Box, Dropbox and Google Drive, are connected. This is both significant and innovative because it allows organizations to both embrace the bring your own cloud (BYOC) movement, allow users to use systems of their choice, while still leveraging their previous and ongoing investments in the more traditional corporate systems such as SharePoint and Salesforce.

### DESCRIPTION OF THE DRAWINGS

The present disclosure is illustratively shown and described in reference to the accompanying drawing in which:

FIG. 1 is a conceptual diagram of a network topology in which the system may be implemented in accordance with various embodiments of the present disclosure;

FIG. 2 is a conceptual diagram of a computer architecture in accordance with various embodiments of the present disclosure;

FIG. 3 presents conceptually an overview of the Information Extraction (IE) system in accordance with the disclosure;

FIG. 4 is a is a flowchart of the an entity annotation algorithm in accordance with various embodiments of the present disclosure;

FIG. 5 presents conceptually another overview of the Information Extraction (IE) in accordance with various embodiments of the present disclosure; and

FIG. 6 is a conceptual overview of the entity—relationship model in accordance with various embodiments of the present disclosure.

### DETAILED DESCRIPTION

### System Architecture

FIG. 1 illustrates a network topology in which the components illustrated in FIG. 2 and may be organized. Note that any of the systems illustrated in FIG. 1 may be interoperably connected either through a wide area network (WAN) 25 or local area network (LAN) 32 or both, or any hybrid combination thereof using known network components, protocols and topologies. FIG. 1 also illustrates multiple user systems 12A-B and 30, which typically represents the user accessing the web portal of server 22 of the Information Extraction (IE) system 35. The computer architecture described with reference to FIG. 2 herein may be to implement any of the systems illustrated in FIG. 1.

Referring to FIG. 1, a computer system 500 comprises a central processing unit 502 (CPU), a system memory 530, including one or both of a random access memory 532 (RAM) and a read-only memory 534 (ROM), and a system bus 510 that couples the system memory 530 to the CPU 502. An input/output system containing the basic routines that help to transfer information between elements within the computer architecture 500, such as during startup, can be stored in the ROM 534. The computer architecture 500 may further include a mass storage device 520 for storing an operating system 522, software, data, and various program modules, such as analytics engine 524.

The mass storage device 520 may be connected to the CPU 502 through a mass storage controller (not illustrated) connected to the bus 510. The mass storage device 520 and its associated computer-readable media can provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media that can be accessed by the computer architecture 500.

By way of example, and not limitation, computer-readable media may include volatile and non-volatile, removable and non-removable media implemented in any method or technology for the non-transitory storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer architecture 500.

According to various embodiments, the computer architecture 500 may operate in a networked environment using logical connections to remote physical or virtual entities through a network such as the network 599. The computer architecture 500 may connect to the network 599 through a network interface unit 504 connected to the bus 510. It will be appreciated that the network interface unit 504 may also be utilized to connect to other types of networks and remote computer systems. The computer architecture 500 may also include an input/output controller for receiving and processing input from a number of other devices, including a keyboard, mouse, or electronic stylus (not illustrated). Similarly, an input/output controller may provide output to a video display 506, a printer, or other type of output device. A graphics processor unit 525 may also be connected to the bus 510.

As mentioned briefly above, a number of program modules and data files may be stored in the mass storage device 520 and RAM 532 of the computer architecture 500, including an operating system 522 suitable for controlling the operation of a networked desktop, laptop, server computer, or other computing environment. The mass storage device 520, ROM 534, and RAM 532 may also store one or more program modules. In particular, the mass storage device 520, the ROM 534, and the RAM 532 may store the analytics engine 524 for execution by the CPU 502. The index management engine 524 can include software components for implementing portions of the processes discussed in detail with respect to FIG. 10. The mass storage device 520, the ROM 534, and the RAM 532 may also store other types of program modules.

Software modules, such as the various modules within the analytics engine 524 may be associated with the system memory 530, the mass storage device 520, or otherwise. According to embodiments, the analytics engine 524 may be stored on the network 599 and executed by any computer within the network 599.

The software modules may include software instructions that, when loaded into the CPU 502 and executed, transform a general-purpose computing system into a special-purpose computing system customized to facilitate all, or part of, the techniques disclosed herein. As detailed throughout this description, the program modules may provide various tools or techniques by which the computer architecture 500 may participate within the overall systems or operating environments using the components, logic flows, and/or data structures discussed herein.

The CPU 502 may be constructed from any number of transistors or other circuit elements, which may individually or collectively assume any number of states. More specifically, the CPU 502 may operate as a state machine or finite-state machine. Such a machine may be transformed to a second machine, or specific machine by loading executable instructions contained within the program modules. These computer-executable instructions may transform the CPU 502 by specifying how the CPU 502 transitions between states, thereby transforming the transistors or other circuit elements constituting the CPU 502 from a first machine to a second machine, wherein the second machine may be specifically configured to manage the generation of indices. The states of either machine may also be transformed by receiving input from one or more user input devices associated with the input/output controller, the network interface unit 504, other peripherals, other interfaces, or one or more users or other actors. Either machine may also transform states, or various physical characteristics of various output devices such as printers, speakers, video displays, or otherwise.

Encoding of executable computer program code modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory 530 when the software is encoded therein. For example, the software may transform the state of transistors, capacitors, or other discrete circuit elements constituting the system memory 530.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

### System for Information Extraction and Sentiment Analysis

The Information Extraction component systemizes massive amounts of web, internal, external, structured or unstructured information into entity based relational knowledge base, Following are the key components of this system:
1. Named entity recognizer: Named entity recognition is the task of recognizing proper names or their references in text. Our Named entity recognition system broadly classifies the entities as Primary Entities, Secondary Entities and Link Entities. The Primary Entities represent proper nouns of the form Person, Organization and Product. The Secondary Entities represent the attributes of the Primary Entities such as Job Title, Location, Address, Phone, Date, Color, Education and Currency etc. The Link entities represent the incidents, relational hierarchy, and the events/actions taking place between or around the primary entities.
2. Profile Generator: This component extract the higher-level relationships among primary, secondary and link entities, such as relating people to companies, professional roles and people, people or company and contact information etc.
3. Profile Matcher: This component aims at distinguishing multiple person entities of same name.
4. Event tracker and classifier: This component is focused on detecting major events taking place in-between the entities.

An auto linker application automatically links content to the companies and individuals in client system based on their profiles. In case of more than one individual with same name, a profile comparison is performed to distinguish between individuals.

Information Extraction refers to the automatic extraction of structured information such as entities, relationships between entities, and attributes describing entities from unstructured sources. The extraction of structure from noisy, unstructured sources is a challenging task the methodology for analyzing such data and extracting information from it is in the cross-road of different areas of Computer Science, such as the Natural Language Processing (NLP), Machine Learning (ML), and Data Mining (DM). The focus of this report is on applying these methodologies to extraction of such data from news articles and blogs of various domains.

FIG. 3 presents conceptually a high level overview of the proposed Information Extraction (IE) system in accordance with the disclosure. The disclosed system processes information exchange using the following methodology:
5. Named entity recognition, which is the task of recognizing proper names or their references in text:
6. Relation detection and classification, which is the task of recognizing relations between entities
7. Event detection and classification, which is focused on detection of events, each of which typically includes several relations
8. Template filling, which aims at filling information about some larger scenarios or templates that occur with a significant frequency
9. Profile Matching, which aims at distinguishing person entity, whether they are listed in the existing database or whether it is a brand new individual profile
10. The particular tasks of extraction of named entities, such as people, company and product names, with recognition of additional concepts, such as locations, professional roles, expertise, contact information and other user defined entities.
11. The extraction of higher-level relationships among those entities, such as relating people to companies, professional roles and people, people or company and contact information and profile matching to distinguish between person entities.

### Named Entity Recognition

Named Entities are typically Noun Phrases and comprise of one to a few tokens in the unstructured text. The most popular form of entities is named entities like names of persons, locations, and companies as popularized in the MUC, ACE, and CoNLL competitions. The Named Entity Recognition algorithm broadly classifies the entities as Primary Entity, Secondary Entity and Link Entity, The Primary Entities represent proper nouns of the form Person name, Organization name and Product name. The Secondary Entities represent the attributes of the Primary Entities such as Job Title, Location, Address, Date, Color, Education and Currency. The link entities represent the Incidents, Relational Hierarchy, the events taking place between the primary Entities and the adjectives of the Primary Entities, The Incidents represents any type of the user specified activities, for example, hire, merger, acquisition etc. The basic entity annotation is performed using Annie Creole of the Gate API, The Entity Annotation Algorithm is divided into the following functional modules:
1. Gazetteer Training Module performs the following functions:
   i. Allow the system to train and annotate new Entity Type: For example, with this module, the user can train interesting incidents of his domain, say, “hire”, as type “Incident”. So that in future any form of “hire”, such as “hiring”, “hired” and its synonyms will be annotated as “Incident”.
   ii. Enable the system to change the type of an annotated entity: This module enables the user to change the type of an entity. For example, an entity “Apple” from Organization to “Product” or Amazon from Location to Organization.
   iii. Enable the system to ignore an entity: For example, the basic annotation of the entity “model” in GATE API is “Job Title”. However, when it deals with a Product, entity “model” of given type is no more significant. This module gives provision to ignore the influence such entities.
2. Execute Entity Annotation Module on the Improved Gazetteer
   The Entity Annotation is performed on the preprocessed article returned by the Preprocessing Wrappers. For Entity Annotation GATE API is used. However, while annotating, instead of the built in GATE Gazetteer, the improved Gazetteer from Gazetteer Training Module is used. While annotating, we bind each entity of the articles with Entity Opening Tag, Entity Close Tag, Entity Identifier, Repositioning Information and Co-reference Identifier. This binding information is used in the coming modules. All Primary, Secondary and Link Entities are stored into the relational database tables.
3. Perform Natural Language Disambiguation
   Using the annotated article and Co-reference identifier, Natural Language Disambiguation is performed. This process is to replace all pronouns into the corresponding proper nouns.
4. Perform Parts Of Speech (POS) Tagging and Noun Phrase (NP) Chunking Methods of Gate API are used for POS Tagging and NP chunking. This module performs the following tasks:
   i. Track all un-annotated Proper Nouns of the article. We define them as Ambiguous Entities. Processing of the Ambiguous Entities is mentioned in the next step
   ii. Track general events (activities) and adjectives of the article.
5. Track Ambiguous Entities module—algorithm to help to reduce the number missing entities and functions to:
   i. Preprocess the article after Step 4 and find all un-annotated proper noun chunks of the articles
   ii. Pass it into a classifier and decide whether it is a Product Entity or Ambiguous Entity. The design specifications of the classifier is discussed in Section 6 module
   iii. In case of Ambiguous Entity, decide its significance by applying statistical methods. Design of this component is discussed in Section 7 module
   iv. In case of a good significance, request the user to label it (as any of the Primary/Secondary/Link Entity type) and store it in the appropriate entity table. An entity will be in a dormant state until it is significant. A dormant entity will not appear for labeling.
   v. Point the entity and user mentioned label into the Gazetteer training module to ensure that this entity is properly annotated in future.
6. Product Vs Ambiguous Entity Classifier module functions to:
   i. Using a web crawler, the best-selling tech products are downloaded from www.amazon.com
   ii. Ingested the best-selling products into Gate Gazetteer and few thousand articles from technical feeds are annotated.
   iii. Passed the annotated articles into POS Tagger and n-grams of size 5 around the product Entity (including the product entity) is generated and labeled as ProductType
   iv. Few thousand non-technical feeds are also annotated and did POS Tagging. 5-grams around the Person/Organization entity is generated and labeled as NonProduct Type.
   v. A binary decision tree classifier is trained and optimized using the generated n-grams.
   vi. To test the type of an unlabeled entity; all possible 5-grams around that entity is generated and cross validated across the trained model. If Product, the entity is stored as the Primary Entity.
7. Unlabeled Entity Scoring
   The frequency of occurrence of unlabeled entities follows the Power Law distribution. After analyzing this distribution for a sample dataset, we decided a range of frequency cut-off. All unlabeled entities with frequency lower than this cut-off will remain as a dormant entity.
8. Event, Adjective Tracking
   Events are the text attached to an entity that has one or more terms with any of the verbal tags. Similarly, Adjectives are the text attached to an entity that has one or more terms with an adjective tag.
9. Event, Adjective Scoring
   Event and adjective scoring is performed using tf-idf weighting algorithm. In order to improve the processing speed, a corpus of more than 25,000 frequent verbal and adjective stems and their weight is populated using thousands of samples and stored in the database. The significant events and adjectives information is stored in the database for the next phase.
      The information gathered in Step 2 (Named Entities), Step 7(Ambiguous Entities) and Step 9 (Events and Adjectives) and disambiguated article (Step 3) are stored in the database tables and used for Information Extraction discussion in the next chapter.

### Information Extraction

In Information Extraction Module, relationships are defined over two or more entities related in a predefined way. Examples are “is employee of” reflects the relationship between a person and an organization, “is acquired by” relationship the relationship between pairs of companies, and “is price of” reflects the relationship between a product name and a currency amount.

Besides detecting relations between entities and concepts, the relations are also classified; namely, it is determined which kind of relation is in question. For example, after detecting a relation between a person and a company, we need to know more about the kind of relation between them: a person can be employed by a company, could have a specific position within a company, or be related in some other, quite different way to the company.

Using the entities and their relation, Profile generation is performed. It is the process of the formulation of a frequent event pattern of interest, such as a frequent scenario, or template. For example, employee hire can be seen as frequent templates, with fields such as: person name previous company (company-1), hired by (company-2), job title, location of company-1, location of company-2, contact information (of company-1, company-2, person) etc. One would also need to distinguish different templates when it deals with person entity, whether they are listed in their database or whether it is a brand new individual profile, known as Profile Matching. FIG. 3.1 represents the overview of the Information Extraction System.

### Entity Based Line Recreation and Pre-Processing Module

Main functions of this module are as follows:
Taking each line of the disambiguated article
For all Primary Secondary and Link Entities
   i. Store the start position and the entity name in a sorted list (sort by position)
   ii. Merge all consecutive secondary entities into a single entity and reset position as the start position of the first entity
   iii. Merge all consecutive link entities into a single entity and reset position as the start position of the first entity
   iv. Applying a set of predefined rules, for each Primary entity and create a triplet of Secondary/Link Entity and another Primary Entity (aka Chaining)
   v. Pass the triplets to Template Element and Template Relation Construction discussed in Section 2
1. Template Element and Template Relation Construction
   In this module, the triplets created in Step 1 are cross validated across a set of decision rules. Main functions of this module are:
      i. In Template Element Construction, the triplets are validated across a set of rules and check the accuracy of the Secondary entity attributes associated with each entity.
      ii. In Template Relation Construction, the relation between two primary entities defined in Section 1 is cross validated.
      ii. If possible, using multiple triplets and the relative positioning of the entities, Second Order Inference is also generated.
      iv. Generate profile for Primary Entities (based on a predefined template; for example for individual the template structure is: Current Job Title, Current Organization, Previous Organization, Previous Job Title, Location, Contact Address)
2. Profile Matching
   In case of more than one individual with same name, a profile comparison is performed which aims at distinguishing person entity, whether they are listed in the existing database or whether it is a brand new individual profile. Main steps of profile matching are as follows:
      i. Generate the signature of the existing individuals with same name. Signature is a set of key terms from 4Sight ECM regarding that person's professional employment history.
      ii. Generate the signature of the individual that found (say Query Signature)
      iii. Calculate the cosine similarity between the Query Signature and each of the signatures generated in Step 1.
      iv. The cosine value varies between 0 and 1. A similarity of 0 means these profiles are totally different whereas cosine similarity of 1 means they are exact duplicate.
         It will be obvious to those recently skilled in the art that modifications to the apparatus and process disclosed here in may occur, including substitution of various component values or nodes of connection, without parting from the true spirit and scope of the disclosure.

What is claimed is:

1. An apparatus as described herein and as shown in the Figures, including any limitation or embodiment.

2. A method of operation as described herein and as shown in the Figures, including any limitation or embodiment.
